(19) United States
(12) Patent Application Publication
(10) Pub. No.: US 2022/0178254 A1
(43) Pub. Date: Jun. 9, 2022

(54) CUTTING DEVICE

(71) Applicant: Nanjing Chervon Industry Co., Ltd, Nanjing (CN)

(72) Inventors: Zhifeng Chen, Nanjing (CN); Dianbo Zhu, Nanjing (CN); Huaping Pan, Nanjing (CN); Changning Zhang, Nanjing (CN)

(21) Appl. No.: 17/542,593

(22) Filed: Dec. 6, 2021

(30) Foreign Application Priority Data
Dec. 7, 2020 (CN) 202011418457.6
Dec. 7, 2020 (CN) 202011419344.8
Dec. 7, 2020 (CN) 202011419346.7

(51) Int. Cl. E21C 25/16; E21C 31/02

(52) U.S. Cl. CPC E21C 25/16; E21C 31/02

(57) ABSTRACT

A cutting device includes a base, an operation bench, and a cutting mechanism. The base includes a fluid cavity for containing a fluid. The operation bench is disposed on the base. The cutting mechanism includes a driving member and a cutting member. The driving member drives the cutting member to rotate. The cutting member at least partially protrudes from and passes through the operation bench. The cutting device includes a fluid control mechanism including a radial flow guiding member. The radial flow guiding member is disposed in the fluid cavity and includes at least a flow guiding surface disposed around a periphery of the cutting member. The fluid is capable of flowing along a surface of the flow guiding surface and the flow guiding surface is inclined or curved with respect to a bottom wall of the fluid cavity.

### RELATED APPLICATION INFORMATION

This application claims the benefit under 35 U.S.C. § 119(a) of Chinese Patent Application No. CN 202011419346.7, filed on Dec. 7, 2020, Chinese Patent Application No. CN 202011418457.6, filed on Dec. 7, 2020, and Chinese Patent Application No. CN 202011419344.8, filed on Dec. 7, 2020, which applications are incorporated herein by reference in their entirety.

### TECHNICAL FIELD

The present disclosure relates to a power tool and, in particular, to a cutting device.

### BACKGROUND

A conventional cutting device includes a cutting member capable of cutting a workpiece and a workbench. During a cutting process, the cutting member generates heat and becomes hot. In order to avoid overheating of the cutting member, a coolant for cooling the cutting member is typically disposed on the workbench. The cutting member is partially immersed in the coolant. During a cutting operation, the cutting member rotates and the heat is taken away by the coolant.

However, during use of a cutting device, a cutting member rotating at a high speed easily takes away a coolant in a fluid cavity, and the coolant will be splashed under the action of a centrifugal force in the process of being taken away by the cutting member. On the one hand, the splashed coolant pollutes a working environment and cannot be recycled, resulting in low use efficiency. It is necessary to add the coolant frequently, which is not conducive to improving user experience. On the other hand, the splashed coolant mixed with cutting debris easily contaminates a surface of the workpiece and blocks a cutting line, affecting the line of sight of a user for operation and cutting accuracy.

In order to solve the preceding problems, at present, baffles or bosses are disposed at two axial ends of the cutting member in the fluid cavity to partially surround and shield the cutting member so as to alleviate the splashing when the coolant is taken away from a liquid surface. It has been proved that the preceding method can merely alleviate the splashing slightly and has an insignificant effect.

### SUMMARY

In one example, a cutting device includes: a base, an operation bench, and a cutting mechanism. The base includes a fluid cavity for containing a fluid. The operation bench is disposed on the base. The cutting mechanism includes a driving member and a cutting member, where the driving member drives the cutting member to rotate and the cutting member at least partially protrudes from and passes through the operation bench. The cutting device further includes a fluid control mechanism, where the fluid control mechanism includes a radial flow guiding member disposed in the fluid cavity and including at least a flow guiding surface disposed around a periphery of the cutting member, where the fluid is capable of flowing along a surface of the flow guiding surface, and the flow guiding surface is inclined or curved with respect to a bottom wall of the fluid cavity.

In one example, a cutting device includes: a base, an operation bench, and a cutting mechanism. The base includes a fluid cavity for containing a fluid. The operation bench is disposed on the base. The cutting mechanism includes a driving member and a cutting member, where the driving member drives the cutting member to rotate and the cutting member at least partially protrudes from and passes through the operation bench. The cutting device further includes a flow guiding cover detachably disposed in the fluid cavity and including a main housing portion disposed around a periphery of the cutting member, where the fluid is capable of flowing along an inner wall of the main housing portion, and the inner wall of the main housing portion is inclined or curved with respect to a bottom wall of the fluid cavity.

In one example, a cutting device includes: a base, an operation bench, and a cutting mechanism. The base includes a fluid cavity for containing a fluid. The operation bench is disposed on the base. The cutting mechanism includes a driving member and a cutting member, where the driving member drives the cutting member to rotate and the cutting member at least partially protrudes from and passes through the operation bench. The cutting device further includes a flow guiding cover detachably disposed in the fluid cavity and including a main housing portion disposed around a periphery of the cutting member, where the main housing portion at least partially surrounds one side of the cutting member, and the fluid is capable of flowing along an inner wall of the main housing portion; and the flow guiding cover moves with respect to the cutting member.

### BRIEF DESCRIPTION OF DRAWINGS

FIG. 1 is a structure view of a cutting device of the present disclosure;

FIG. 2 is a structure view of a cutting device with an operation bench removed according to an example of the present disclosure;

FIG. 3 is a sectional view of the cutting device in FIG. 2 taken along A-A;

FIG. 4 is a structure view of the cutting device in FIG. 2 with a fluid cavity cut open;

FIG. 5 is a structure view of the cutting device in FIG. 4 with a cutting member removed;

FIG. 6 is a sectional view of the cutting device in FIG. 5 taken along B-B;

FIG. 7 is a structure view of a cutting device with an operation bench removed according to an example of the present disclosure;

FIG. 8 is a schematic view illustrating assembly of a cutting member and a flow guiding cover of the cutting device in FIG. 7;

FIG. 9 is a front view of the cutting member assembled to the flow guiding cover of the cutting device in FIG. 8;

FIG. 10 is a structure view of a flow guiding cover of the cutting device in FIG. 7;

FIG. 11 is a structure view of a flow guiding cover of the cutting device in FIG. 7 from another angle;

FIG. 12 is a structure view of a cutting device with an operation bench removed according to an example of the present disclosure;

FIG. 13 is a sectional view of the cutting device in FIG. 12 taken along C-C;

FIG. 14 is a structure view of a barrier mechanism of the cutting device in FIG. 12;

FIG. 15 is a right view of the barrier mechanism in FIG. 14;

FIG. 16 is a left view of the barrier mechanism in FIG. 14;

FIG. 17 is a structure view of a cutting device with an operation bench removed according to an example of the present disclosure;

FIG. 18 is a structure view of a cutting device with an operation bench removed according to an example of the present disclosure;

FIG. 19 is a partial structure view of a cutting device according to an example of the present disclosure; and

FIG. 20 is a structure view of a flow guiding cover in FIG. 19.

### DETAILED DESCRIPTION

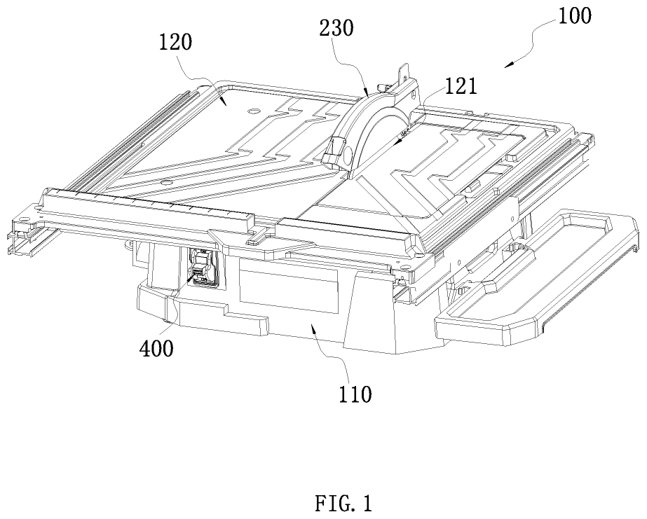

As shown in FIG. 1, a cutting device 100 of the present disclosure is provided. Specifically, the cutting device 100 is a tile cutter which may be used for cutting tiles, marble, granite, and the like. The cutting device 100 includes a base 110, an operation bench 120, and a cutting mechanism.

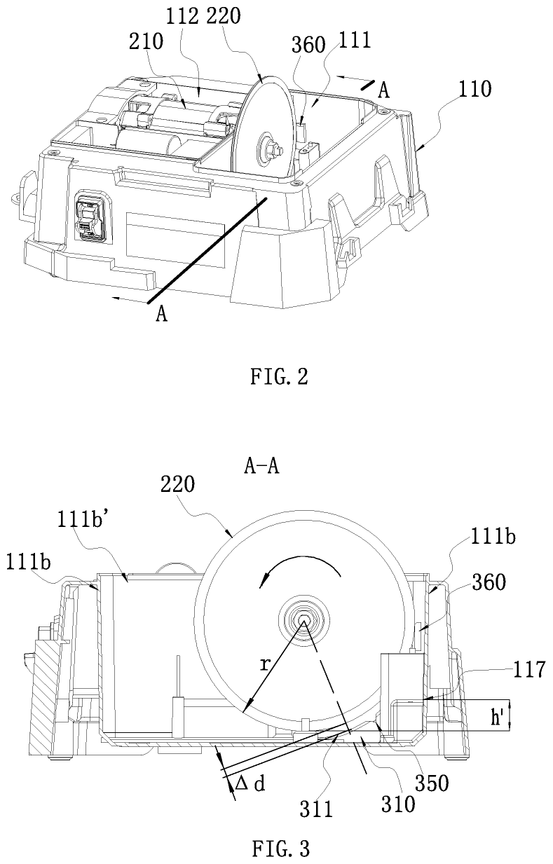

As shown in FIGS. 1 and 2, the cutting device 100 further includes a switch assembly 400 and a control assembly (not illustrated in the figures). The control assembly is configured to control an operation of the cutting device 100. The switch assembly 400 is connected to a driving member 210 and the control assembly separately so as to control the driving member 210 to be started or stopped.

The base 110 may be placed on a ground or another workbench. As shown in FIG. 2, a mounting cavity 112 and a fluid cavity 111 are disposed in the base 110. The fluid cavity 111 is used for containing a coolant. A water discharge hole 114 for discharging a fluid is disposed at a bottom of the fluid cavity 111. A funnel-type drainage design is provided on the periphery of the water discharge hole 114 so as to facilitate smooth drainage of the internal fluid. Both the fluid cavity 111 and the mounting cavity 112 in this example are recessed cavities formed directly in the base 110. Of course, the fluid cavity 111 may be provided as a separate basin or housing and connected and fixed to the base 110.

As shown in FIG. 1, the operation bench 120 is disposed on the base 110 and used for placing a workpiece for a user to perform a cutting operation. The operation bench 120 covers an opening of the fluid cavity 111. Of course, the operation bench 120 is provided with an opening 121 through which at least part of a cutting member 220 is allowed to pass. An upper half of the cutting member 220 passes through the opening 121 and a lower half of the cutting member 220 extends into the fluid cavity 111.

Referring to FIG. 2, the cutting mechanism includes the driving member 210 and the cutting member 220. Specifically, the driving member 210 is a motor disposed in the mounting cavity 112 in the base 110, and the cutting member 220 is a saw blade connected to the motor and driven by the motor to rotate. In order to ensure safety of an operator, as shown in FIG. 1, a part of the saw blade exposed above the operation bench 120 is further covered by a shield 230. The driving member 210 in this example is driven by a power source to rotate, and the power source may be a direct-current power supply or an alternating-current power supply, which is not limited here.

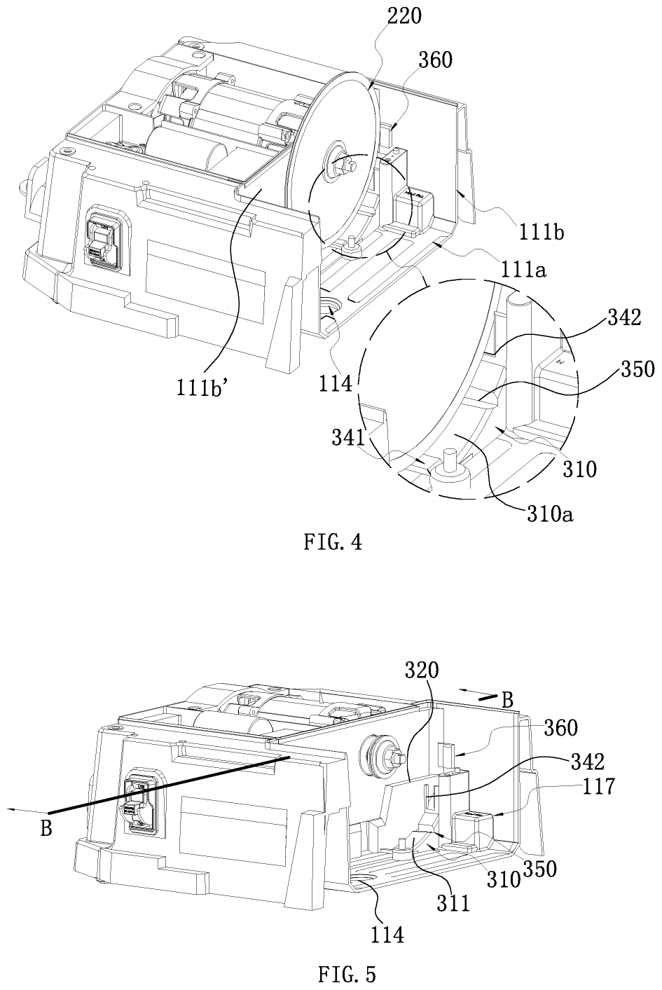

Referring to FIG. 4, the fluid cavity 111 includes a bottom wall 111a and a plurality of sidewalls 111b. The sidewalls 111b approximately extend upward from the bottom wall 111a. The sidewalls 111b make encirclement to form a periphery of the fluid cavity 111. The bottom wall 111a and all the sidewalls 111b make encirclement together to form the fluid cavity 111. In this example, four sidewalls 111b are included and approximately make encirclement to form a rectangular fluid cavity 111. Of course, the number of sidewalls 111b is not limited to four, and the fluid cavity 111 formed through encirclement by the sidewalls 111b is not limited to a rectangular cavity, either.

As shown in FIGS. 3 to 5, the sidewalls 111b include a support sidewall 111b′. The support sidewall 111b′ isolates the fluid cavity 111 from the mounting cavity 112 in the base 110. The support sidewall 111b′ is provided with a mounting hole through which an output shaft of the motor is allowed to pass. The cutting member 220 is mounted at an end of the output shaft of the motor and disposed in the fluid cavity 111.

The fluid cavity 111 is used for containing the coolant, and the cutting member 220 is partially immersed in the coolant. In this example, water is used as the coolant. During a cutting process, when the cutting member 220 rotates through the coolant, the cutting member 220 may be cooled and cleaned simultaneously by the coolant. That is, the coolant in the fluid cavity 111 is used for cooling the cutting member 220 and taking away cutting debris on the cutting member. A height marking unit 117 is further disposed in the base 110. The height marking unit 117 is a structure protruding from the sidewall 111b or the bottom wall 111a. An upper surface is marked conspicuously so as to instruct the user to add the coolant to this height. Therefore, a position at the height marking unit 117 should be a maximum allowable height of a liquid surface of the coolant. As shown in FIG. 3, a difference between a vertical height of the upper surface of the height marking unit 117 and a vertical height of a lower rim of the cutting member 220 in an up-down direction is h′, a radius of the cutting member 220 is r, and 0<h′/r≤⅓; preferably, ⅙≤h′/r≤⅓. When a water level is too high, a large amount of splashes are caused. Such a configuration can avoid water splashing, ensure efficient water utilization, and reduce a frequency at which water is added in the case of an extremely high water level.

Referring to FIGS. 3 to 6, an example of the present disclosure provides a cutting device. The cutting device 100 in this example further includes a fluid control mechanism, where the fluid control mechanism includes a radial flow guiding member 310. The radial flow guiding member 310 is disposed in the fluid cavity 111 and includes at least a flow guiding surface 310a disposed around a periphery of the cutting member 220. The fluid in the fluid cavity 111 flows along a surface of the flow guiding surface 310a, and the flow guiding surface 310a is inclined or curved with respect to the bottom wall of the fluid cavity 111.

The flow guiding surface 310a may include an inclined surface disposed on the periphery of the cutting member 220 and inclined with respect to the bottom wall 111a of the fluid cavity, or the flow guiding surface 310a may include a curved surface disposed on the periphery of the cutting member 220. The flow guiding surface 310a in this example is a flow guiding curved surface 311 disposed around the periphery of the cutting member 220. The flow guiding curved surface 311 is substantially disposed on a circumference with an axis of the cutting member 220 as a center line. Of course, as an alternative example, the flow guiding curved surface 311 may be configured with any other curvature.

Specifically, referring to FIGS. 3 to 6, the radial flow guiding member 310 in this example is a boss disposed in the fluid cavity 111. The boss is an arc-shaped boss, and a curved surface at a top of the arc-shaped boss forms the flow guiding curved surface 311. The flow guiding curved surface 311 is approximately part of a circumferential surface, and the flow guiding curved surface 311 is approximately coaxially disposed with the cutting member 220.

The flow guiding curved surface 311 extends from the bottom wall 111a along a rotation direction of the cutting member 220, and an end portion of the flow guiding curved surface 311 is at least higher than a limit liquid level. Specifically, as shown in FIG. 3, the cutting member 220 in this example rotates along an anti-clockwise direction and the flow guiding curved surface 311 extends from the bottom wall 111a along the anti-clockwise direction. The flow guiding curved surface 311 extends along the periphery of the cutting member 220 which, on the one hand, prevents the coolant driven through rotation of the cutting member 220 from being splashed to a large scale and improves a utilization rate of the coolant and on the other hand, guides the coolant to move in a limited space between the flow guiding curved surface 311 and an outer rim of the cutting member 220 and further improves a cooling effect of the cutting member 220.

Referring to FIG. 3, in order to further improve a flow guiding effect and a splash prevention effect, in this example, a radial gap between the flow guiding curved surface 311 and a rim of the cutting member 220 is set to Δd, the radius of the cutting member 220 is r, and 1/20≤Δd/r≤ 1/9. In this example, 0 mm≤Δd≤10 mm. Specifically, the radial gap Δd may be set to 8 mm.

The gap between the flow guiding curved surface 311 and the outer rim of the cutting member 220 is limited to the preceding range, which can ensure cooling performance of the cutting member 220 and is conducive to preventing the coolant from being splashed. Thus, utilization efficiency of the coolant is improved, the user is prevented from frequently adding the coolant, and environmental pollution caused by the splashing of the coolant is also avoided.

Further, the flow guiding curved surface 311 includes an inflow end and an outflow end. The outflow end is disposed behind the inflow end along the anti-clockwise direction. The inflow end of the flow guiding curved surface 311 in this example is immersed in the coolant, and the outflow end of the flow guiding curved surface 311 protrudes out of the coolant.

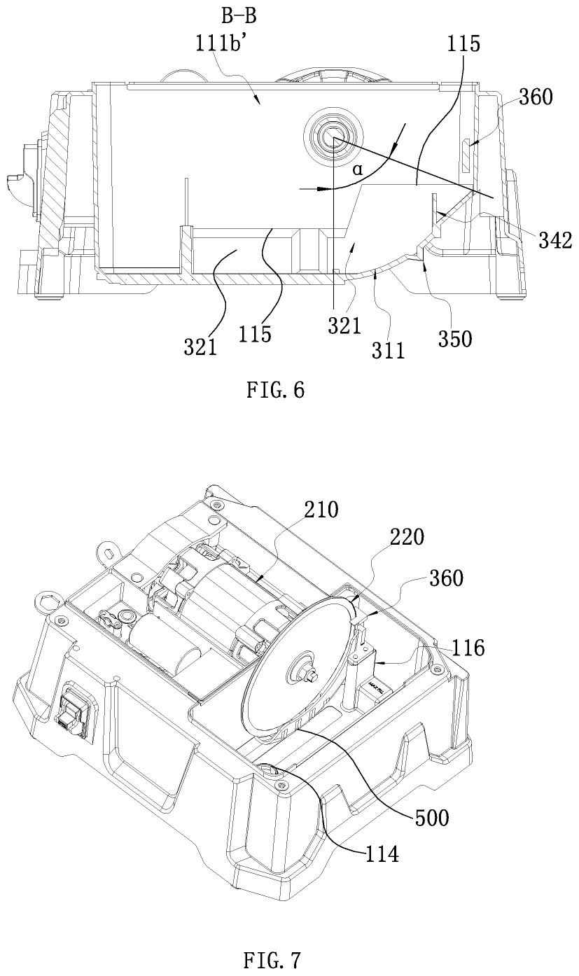

Specifically, as shown in FIG. 6, in this example, the flow guiding curved surface 311 extends from a position directly below the cutting member 220 along the rotation direction of the cutting member 220 by an angle α, where α≥70°. For example, a is 70°, 90°, 120°, or the like. Thus, it can be ensured that the flow guiding curved surface effectively guides a flow and prevents splashing. It is to be understood that the position directly below the cutting member 220 refers to the lowest position through which the cutting member 220 rotates.

The preceding configuration is conducive to smoothly and effectively guiding the coolant in the fluid cavity 111 to the flow guiding curved surface 311 and to move along the gap between the flow guiding curved surface 311 and the cutting member 220 and ensures an effective cooling path, which further improves cooling of the cutting member by the coolant and prevents the coolant from being splashed.

As shown in FIGS. 5 and 6, the fluid control mechanism further includes an axial flow guiding unit 320. The axial flow guiding unit 320 includes a flow guiding plane surface 321 disposed on at least one axial side of the cutting member 220 and spaced apart from the cutting member 220. An axial gap between the flow guiding plane surface 321 and a surface of the cutting member 220 is g1, and 1/20≤g1/r≤⅛, for example, 1/11≤g1/r≤ 1/10. Thus, in this example, an outer end surface of a plane boss formed on the support sidewall 111b′ forms the flow guiding plane surface 321, and the axial gap g1 between the flow guiding plane surface 321 and the surface of the cutting member 220 satisfies that 0 mm<g1≤8 mm, for example, g1 is 8 mm, 6 mm, 5 mm, 3 mm, or the like.

Specifically, as shown in FIG. 6, in this example, the support sidewall 111b′ is provided with a plane boss 115 protruding from a surface of the support sidewall 111b′. The outer end surface of the plane boss 115 is parallel to the surface of the cutting member 220 and forms one flow guiding plane surface 321. Further, in this example, a height of the plane boss 115 is h, the radius of the cutting member 220 is r, and ¼≤h/r≤1. For example, it may be specifically set that ⅓≤h/r≤⅔. Thus, it can be ensured that a height or an area for the coolant to pass through at two axial ends of the cutting member 220 is effectively limited. The height h refers to a dimension of the plane boss 115 along a direction perpendicular to the bottom wall 111a or a dimension of the plane boss 115 in a vertical direction.

Of course, as an alternative example, another flow guiding plane surface 321 may also be disposed on an outer side of the cutting member 220, where the support sidewall 111b′ is on an inner side of the cutting member 220, and the other side of the cutting member 220 is the outer side. For example, an auxiliary plane boss is disposed on an outer side of the arc-shaped boss opposite to the support sidewall 111b′. An inner wall surface on one side of the auxiliary plane boss facing toward the cutting member 220 forms the other flow guiding plane surface 321. Alternatively, a baffle plate may be disposed on the outer side of the cutting member 220. An inner wall surface of the baffle plate facing toward the cutting member 220 forms the other flow guiding plane surface 321. Likewise, an axial gap g between the flow guiding plane surface 321 and the surface of the cutting member 220 also satisfies that 0 mm<g≤8 mm; or g satisfies that 1/20≤g/r≤⅛, for example, 1/11≤g/r≤ 1/10. Likewise, a height h of the auxiliary plane boss satisfies that ¼≤h/r≤1, for example, ⅓≤h/r≤⅔.

The flow guiding plane surface 321 is disposed at the axial end of the cutting member 220 and can further avoid splashing in approximately an axial direction of the cutting member 220 during the cutting process, which further improves a splash prevention effect of the fluid control mechanism and further improves the utilization efficiency of the coolant. The approximately axial direction refers to any direction other than a radial direction of the cutting member 220.

As shown in FIG. 4, the fluid control mechanism in this example further includes a flow blocking unit disposed on the radial flow guiding member 310 and/or the axial flow guiding unit 320. The flow blocking unit is used for blocking a coolant flow and reducing the coolant flow so as to reduce splashing. A radial gap between the flow blocking unit and the cutting member 220 is smaller than the radial gap between the flow guiding curved surface 311 and the cutting member 220, and an axial gap between the flow blocking unit and the cutting member 220 is smaller than an axial gap between the flow guiding plane surface 321 and the cutting member 220. Specifically, in this example, the radial gap and the axial gap between the flow blocking unit and the cutting member 220 are each less than or equal to 6 mm.

Referring to FIGS. 4 and 5, the flow blocking unit may be a rib disposed on the radial flow guiding member 310 and/or the axial flow guiding unit 320. For example, the flow blocking unit may include a first rib 341 disposed on the flow guiding curved surface 311 and used for further reducing a radial water flow gap of the cutting member 220, where the first rib 341 extends on the flow guiding curved surface 311 along the axial direction of the cutting member 220. Alternatively, the flow blocking unit may also include a rib disposed on the axial flow guiding unit 320 and used for further reducing an axial water flow gap of the cutting member 220. Alternatively, the flow blocking unit may further include a second rib 342 disposed on the arc-shaped boss, where the second rib 342 is a U-shaped rib axially across the rim of the cutting member 220, a bottom wall of the second rib 342 is formed on the flow guiding curved surface 311 of the arc-shaped boss, and two sidewalls of the second rib 342 may be formed on components adjacent to the arc-shaped boss, respectively (for example, the sidewall may be formed on the support sidewall 111b′, an adjacent mounting base, or the flow guiding plane surface). The U-shaped rib can simultaneously limit the radial water flow gap and the axial water flow gap of the cutting member 220. In this example, the first rib 341 and the second rib 342 are both disposed, and the first rib 341 and the second rib 342 are spaced apart on the flow guiding curved surface 311 along the rotation direction of the cutting member 220. Of course, the number of flow blocking units is not limited to two and may be set to any number.

Referring to FIGS. 4 and 5, the fluid control mechanism in this example further includes a flow stirring unit 350 disposed on the radial flow guiding member 310 and/or the axial flow guiding unit 320, where the flow stirring unit 350 is recessed on the flow guiding curved surface 311 toward a radially outer side of the flow guiding curved surface 311. Specifically, the flow stirring unit 350 in this example is a groove disposed on the flow guiding curved surface 311 and has an opening which gradually shrinks inward, that is, a dimension of an opening of the groove is larger than a dimension of a bottom of the groove. The groove in this example has a cross-section which is an inverted triangle. The flow stirring unit 350 is disposed to stir the flow, which can limit a flow rate of the coolant and further prevent the coolant from being splashed. Of course, the flow stirring unit may also be disposed on the axial flow guiding unit 320, or the flow stirring unit 350 may be disposed on both the radial flow guiding member 310 and the axial flow guiding unit 320.

Referring to FIGS. 2 to 5, the fluid control mechanism further includes a flow jamming member 360, where the flow jamming member 360 is at least a soft baffle pad disposed downstream of the radial flow guiding member 310, and a gap between the flow jamming member 360 and the cutting member 220 is smaller than a gap between the flow blocking unit and the cutting member 220. Specifically, the flow jamming member 360 may be a rubber pad which may be independently fixed on a mounting base in the fluid cavity 111 or may be fixed on the sidewall of the fluid cavity 111. The downstream refers to a rear position in the rotation direction of the cutting member 220. The soft baffle pad in this example is disposed above the outflow end of the flow guiding curved surface 311. Specifically, the soft baffle pad is disposed at a position where the cutting member 220 in the fluid cavity 111 is about to rotate out of the fluid cavity 111 and rotate above the operation bench 120. The flow jamming member 360 is a final obstacle to the coolant and used for finally controlling an amount of the coolant rotating out with the cutting member 220, so as to avoid a large amount of splashes at a position of the operation bench 120 where the cutting member 220 exits, prevent an excessive coolant from being brought out through rotation of the cutting member 220 and accumulated on a surface of the operation bench, and further prevents a large amount of dirty water from obscuring a cutting line and affecting cutting accuracy.

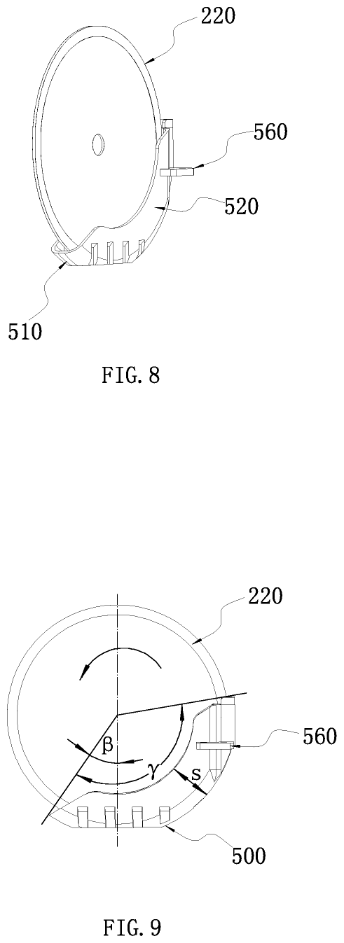

Referring to FIGS. 7 to 11, an example of the present disclosure provides a cutting device. The cutting device 100 in this example includes a flow guiding cover 500. The flow guiding cover 500 is disposed at least around a periphery of a cutting member 220 immersed in a coolant. The flow guiding cover 500 is connected to an inner wall of a fluid cavity 111 or connected to a mounting boss 116 disposed in the fluid cavity 111. Specifically, as shown in FIGS. 8 to 10, the flow guiding cover 500 includes a connection portion 560. The connection portion 560 may be fixedly connected to the mounting boss 116 through, for example, a pin shaft, a screw, or the like, or the connection portion 560 may be inserted into or engaged into the mounting boss 116.

Referring to FIGS. 8 to 11, the flow guiding cover 500 in this example includes a main housing portion 510 disposed in the fluid cavity 111. The main housing portion 510 includes an inner wall of the main housing portion. The inner wall of the main housing portion is disposed along an outer rim of the cutting member 220, a fluid may flow along the inner wall of the main housing portion 510, and the inner wall of the main housing portion is inclined or curved with respect to a bottom wall of the fluid cavity 111.

The inner wall of the main housing portion may include an inclined surface inclined with respect to a bottom wall 111a of the fluid cavity or may include a curved surface. In this example, the inner wall of the main housing portion includes a flow guiding curved surface 311. The flow guiding curved surface 311 is substantially disposed on a circumference with an axis of the cutting member 220 as a center line. Of course, as an alternative example, the flow guiding curved surface 311 may be configured with any other curvature.

The preceding configuration, on the one hand, prevents the coolant driven through rotation of the cutting member 220 from being splashed to a large scale and improves a utilization rate of the coolant and on the other hand, guides the coolant to move in a limited space between the flow guiding cover 500 and the outer rim of the cutting member 220 and further improves a cooling effect of the cutting member 220.

Specifically, referring to FIG. 11, the inner wall of the main housing portion in this example is a curved surface and forms a circumferential flow guiding unit 511. The circumferential flow guiding unit 511 is approximately part of a circumferential surface and is approximately coaxially disposed with the cutting member 220. In other words, the main housing portion 510 in this example is a curved housing, that is, the main housing portion 510 forms part of the circumferential surface.

Of course, as an alternative example, the main housing portion 510 is not limited to the curved housing and may have any shape, such as a rectangle, a trapezoid, or even an irregular shape as long as the inner wall of the main housing portion includes the circumferential flow guiding unit disposed around the periphery of the cutting member.

As shown in FIG. 9, the circumferential flow guiding unit 511 in the flow guiding cover 500 in this example extends approximately along a rotation direction of the cutting member 220. In this example, the cutting member 220 rotates along an anti-clockwise direction in FIG. 9, and the circumferential flow guiding unit 511 also extends along the anti-clockwise direction. If the circumferential flow guiding unit 511 extends along the rotation direction of the cutting member 220 by an angle γ, where γ≥120°. For example, γ is 120°, 150°, or the like.

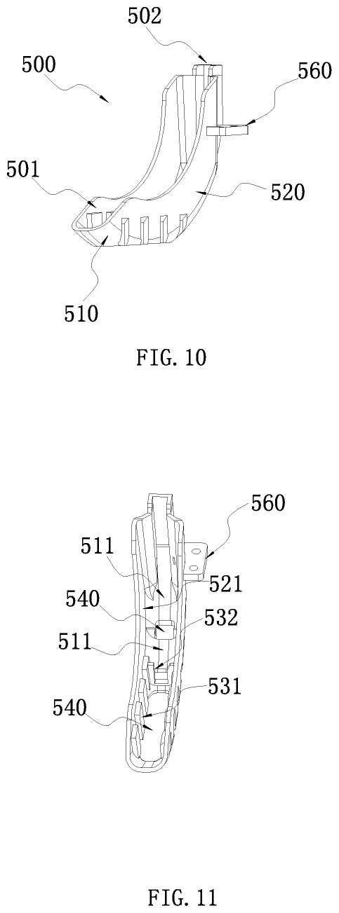

Further, referring to FIG. 10, the flow guiding cover 500 includes a guiding-in end 501 and a guiding-out end 502, where the guiding-in end 501 is lower than a limit liquid level, and the guiding-out end 502 is higher than the limit liquid level. Specifically, when the fluid cavity 111 is provided with a lower limit liquid level and an upper limit liquid level, the guiding-in end 501 of the flow guiding cover 500 is lower than the lower limit liquid level so that it is can be ensured that the coolant can smoothly enter the guiding-in end 501, and the guiding-out end 502 of the flow guiding cover 500 is higher than the upper limit liquid level. It is to be understood that such a structural configuration is conducive to smoothly and effectively guiding the coolant in the fluid cavity 111 to enter the flow guiding cover 500 and move along a gap between the flow guiding cover 500 and the cutting member 220 and ensures an effective cooling path, which further improves cooling of the cutting member by the coolant and prevents the coolant from being splashed.

With continued reference to FIG. 9, in this example, the main housing portion 510 extends from a lower limit position of the cutting member 220 along a direction opposite to the rotation direction of the cutting member 220 by an angle β, where β satisfies that 15° ≤β≤35°. As shown in FIG. 9, the cutting member 220 rotates along the anti-clockwise direction and the flow guiding cover 500 extends clockwise from the lower limit position of the cutting member 220 by the angle β, where 15°≤β≤35°. Thus, the guiding-in end 501 of the flow guiding cover 500 is prevented from protruding out of the coolant, and the coolant can effectively enter the flow guiding cover 500 and cool the cutting member 220. Moreover, the coolant entering the flow guiding cover 500 can be guaranteed to travel a sufficient cooling path so as to ensure the cooling effect on the cutting member 220.

In order to further improve a flow guiding effect and a splash prevention effect, in this example, a radial gap between the circumferential flow guiding unit 511 formed by the inner wall of the main housing portion and a rim of the cutting member 220 is set to Δd′, a radius of the cutting member 220 is r, and 1/20≤Δd′/r≤ 1/9.

In this example, 0 mm<Δd′≤10 mm. Specifically, the radial gap Δd′ may be set to 8 mm. A gap between the main housing portion 510 and the outer rim of the cutting member 220 is limited to the preceding range, which can ensure cooling performance of the cutting member 220 and is conducive to preventing the coolant from being splashed. Thus, utilization efficiency of the coolant is improved, a user is prevented from frequently adding the coolant, and environmental pollution caused by the splashing of the coolant is also avoided.

As shown in FIGS. 8 to 11, the flow guiding cover 500 further includes an axial housing portion 520, where the axial housing portion 520 and the main housing portion 510 may be integrally formed or may be assembled after being separately formed. The axial housing portion 520 in this example extends from an axial end of the main housing portion 510 to an axially outer side of the cutting member 220. It is to be understood that the axial housing portion 520 extends from the axial end of the main housing portion 510 and partially covers the axially outer side of the cutting member 220. In other words, the flow guiding cover 500 blocks not only the outer rim of the cutting member 220 immersed in the fluid but also part of an axial end of the cutting member 220.

Referring to FIG. 9, the axial housing portion 520 in this example extends from the main housing portion 510 to the axial end of the cutting member 220. A radial dimension of the axial housing portion 520 is s, the radius of the cutting member is r, and ¼≤s/r≤½, for example, ¼≤s/r≤⅓.

Referring to FIG. 11, the axial housing portion 520 includes an axial flow guiding unit 521 disposed on each of two axial sides of the cutting member 220 and spaced apart from the cutting member 220. Specifically, in this example, an inner wall of the axial housing portion forms the axial flow guiding unit 521, where an axial gap between the axial flow guiding unit 521 and a surface of the cutting member 220 is g1′, and 1/20≤g1′/r≤⅛, for example, 1/11≤g1′/r≤ 1/10.

In this example, the axial gap g1′ between the axial flow guiding unit 521 and the surface of the cutting member 220 satisfies that 0 mm≤g1′≤8 mm.

It is to be understood that as an alternative example, merely one axial housing portion 520 may be disposed. In this case, the axial housing portion 520 is connected to the main housing portion 510 on the outer side of the cutting member 220; an outer surface of a support sidewall 111b′ on an inner side of the cutting member 220 forms the axial flow guiding unit on the other side of the cutting member 220; or several plane bosses are disposed on the support sidewall 111b′, a plane surface on the plane bosses and parallel to the surface of the cutting member 220 forms one axial flow guiding unit 521. Further, in this example, a height of the plane boss is h′, the radius of the cutting member 220 is r, and ¼≤h′/r≤1. For example, it may be specifically set that ⅓≤h′/r≤⅔.

The axial flow guiding unit 521 is disposed on at least one side of the axial end of the cutting member 220 and can further avoid splashing in approximately an axial direction of the cutting member 220 during the cutting process, which further improves a splash prevention effect of the fluid guiding cover 500 and further improves the utilization efficiency of the coolant. The splashing in approximately the axial direction refers to splashing toward an outer side of an end surface of the cutting member 220 along the axial direction of the cutting member 220 and at an angle with respect to the axial direction of the cutting member 220.

The flow guiding cover 500 in this example further includes a flow blocking unit disposed on the inner wall of the main housing portion 510 and/or an inner wall of the axial housing portion 520. The flow blocking unit is used for blocking a coolant flow and reducing the coolant flow so as to reduce splashing. A radial gap between the flow blocking unit and the cutting member 220 is smaller than a radial gap between the circumferential flow guiding unit 511 and the cutting member 220, and an axial gap between the flow blocking unit and the cutting member 220 is smaller than an axial gap between the axial flow guiding unit 521 and the cutting member 220. Specifically, in this example, the radial gap and the axial gap between the flow blocking unit and the cutting member 220 are each less than or equal to 6 mm.

Referring to FIG. 11, the flow blocking unit may be a rib and/or a protruding block disposed on the main housing portion 510 and/or the axial housing portion 520. For example, the flow blocking unit may include a first protruding block 531 disposed on an inner surface of the axial housing portion 520 and used for further reducing an axial water flow gap of the cutting member 220. Alternatively, the flow blocking unit may further include a second protruding block 532 disposed on an inner wall of the flow guiding cover 500, where the second protruding block 532 is a U-shaped protruding block axially across the rim of the cutting member 220, a bottom wall of the second protruding block 532 is formed on the main housing portion 510, and two sidewalls of the second protruding block 532 may be formed on the axial housing portions 520 separately. The U-shaped protruding block can simultaneously limit a radial water flow gap and the axial water flow gap of the cutting member 220. In this example, several first protruding blocks 531 and the second protruding block 532 are both disposed, and the first protruding blocks 531 are spaced apart from the second protruding block 532.

Referring to FIG. 11, the flow guiding cover 500 in this example further includes an opening 540 disposed on the main housing portion 510 and/or the axial housing portion 520 and used for flow discharge and/or dirt discharge. The flow discharge refers to that the coolant is allowed to flow from the opening 540 back to the fluid cavity 111 and the dirt discharge refers to that cutting chips or debris such as porcelain clay during the cutting process is allowed to be discharged from the opening 540 to the fluid cavity 111. Thus, the cutting member 220 is prevented from being clogged by chips or debris and guaranteed to operate normally.

Referring to FIG. 7, the cutting device 100 in this example further includes a flow jamming member 360, where the flow jamming member 360 is at least a soft baffle pad disposed at an exit end of the main housing portion 510, and a gap between the flow jamming member 360 and the cutting member 220 is smaller than a gap between the flow blocking unit and the cutting member 220. Specifically, the flow jamming member 360 may be a rubber pad which may be fixed on a mounting base or may be fixed on a sidewall of the fluid cavity 111, and the exit end of the main housing portion 510 is an end where the cutting member 220 rotates out of the flow guiding cover 500. The soft baffle pad in this example is disposed transversely at an exit end of the flow guiding cover 500. The flow jamming member 360 is a final obstacle to the coolant and used for finally controlling an amount of the coolant rotating out with the cutting member 220, so as to avoid a large amount of splashes at a position of an operation bench 120 where the cutting member 220 exits, prevent a liquid from being accumulated, and prevent a large amount of dirty water from obscuring a cutting line and affecting cutting accuracy.

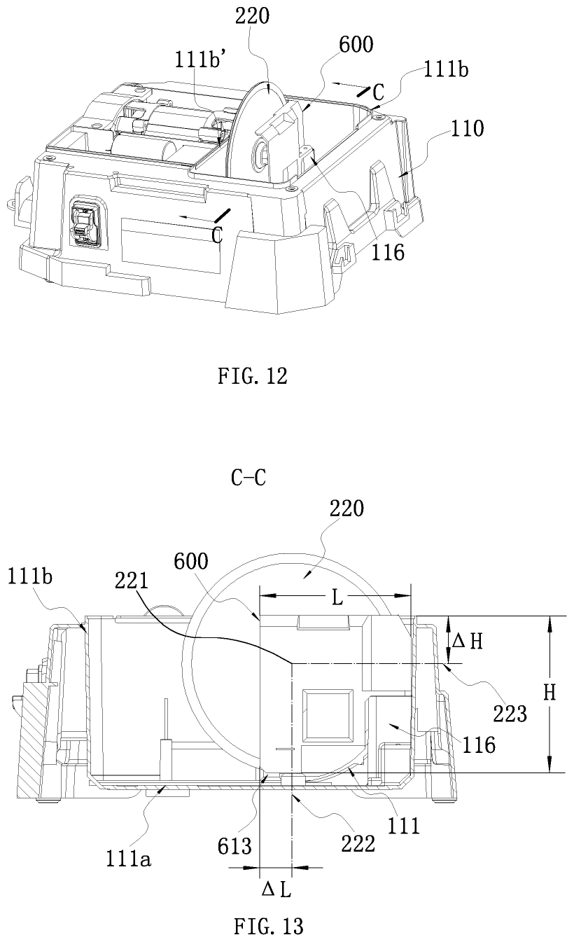

As shown in FIGS. 12 to 16, an example of the present disclosure provides a cutting device. A cutting member 220 is driven by a driving member to rotate about a first axis and has an entry region and an exit region on a rotation path of the cutting member 220. Specifically, the entry region refers to a rotation path where the cutting member 220 enters a coolant and rotates to a lower limit position of the cutting member 220, and the exit region refers to a rotation path where the cutting member 220 rotates from the lower limit position until the cutting member 220 exits from a fluid. In other words, the entry region is a rotation interval between a position where the cutting member 220 is in contact with the fluid and a position where the cutting member 220 is most deeply immersed in the coolant, and the exit region refers to a rotation interval between a position where the cutting member 220 is most deeply immersed in the fluid and a position where the cutting member 220 exists from the coolant.

As shown in FIGS. 12 and 13, in this example, the cutting device 100 is further provided with a barrier mechanism 600. The barrier mechanism 600 is mounted at an axial end of the cutting member in a fluid cavity 111 along a direction approximately perpendicular to the first axis. The barrier mechanism 600 has an axial projection in a direction of the first axis. Referring to FIG. 13, the axial projection covers at least a rotation center 221 of the cutting member 220 and the exit region of the cutting member 220.

Referring to FIG. 13, in this example, the axial projection of the barrier mechanism 600 extends beyond a vertical center line 222 of the cutting member 220 toward the entry region and extends upward beyond a horizontal center line 223 of the cutting member 220. The vertical center line 222 and the horizontal center line 223 are each a center line of the cutting member 220 passing through the rotation center 221 of the cutting member 220. The vertical center line 222 is approximately perpendicular to the ground, and the horizontal center line 223 is approximately parallel to the ground.

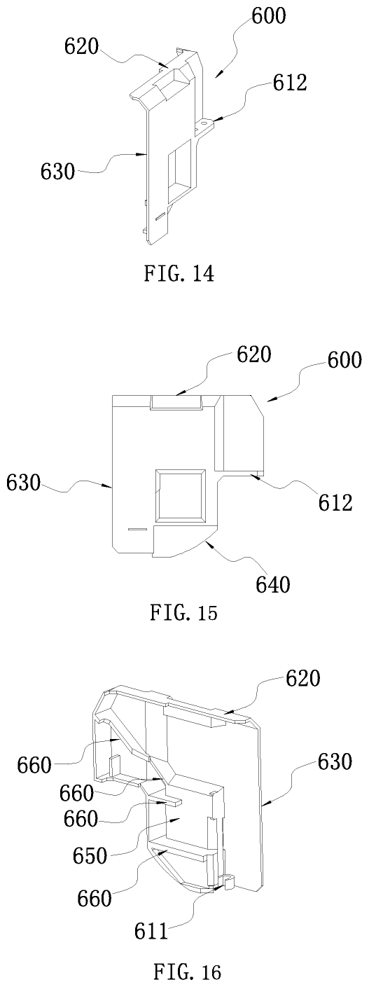

As shown in FIGS. 14 to 16, in this example, the barrier mechanism 600 is a baffle plate disposed in a fluid cavity 111 along a direction approximately perpendicular to the first axis. The barrier mechanism 600 includes a mounting portion for being detachably mounted in the fluid cavity 111.

As shown in FIG. 12, specifically, the barrier mechanism 600 in this example is pivotally connected to a base 110. The mounting portion includes an engaging slot 611 and a fixing lug 612 which are disposed on the barrier mechanism 600. The fixing lug 612 is disposed on an outer side of the exit region, that is, the right side in FIG. 13. A mounting boss 116 is provided with a connection hole detachably connected to the fixing lug 612. During mounting, the fixing lug 612 is pivotally connected to the mounting boss 116 through a pin, a pin shaft, or the like so that the barrier mechanism 600 can rotate around the pin shaft in the fluid cavity 111.

As shown in FIGS. 13 to 16, the engaging slot 611 is disposed at a bottom of the barrier mechanism 600, an insert pin 613 suitable for being inserted into the engaging slot 611 is disposed on a bottom wall 111a of the fluid cavity 111, and the insert pin 613 may be inserted into the engaging slot 611 so that the barrier mechanism 600 is conveniently fixed and unfixed. Of course, the insert pin may be disposed on the barrier mechanism 600, and the engaging slot may be disposed in the fluid cavity 111, which is not limited here.

As an alternative example, the barrier mechanism 600 may also be inserted into an inner wall of the fluid cavity 111 and/or the mounting boss 116. Specifically, the inner wall of the fluid cavity 111 corresponding to the barrier mechanism 600 and/or the mounting boss 116 are separately provided with an inserting slot suitable for being connected to the barrier mechanism 600, the barrier mechanism 600 is provided with the insert pin suitable for being inserted into the inserting slot, and the barrier mechanism 600 is inserted in the fluid cavity 111 along a vertical direction so that the barrier mechanism 600 can be quickly mounted and dismounted by being connected and fixed through the insert pin and the inserting slot. Of course, positions where the insert pin and the inserting slot are disposed may be interchanged. Alternatively, an inserting slot slidably connected to a side of the barrier mechanism 600 is directly disposed in the fluid cavity 111 as long as the barrier mechanism 600 can be inserted into the fluid cavity 111, which is not limited here.

Of course, as an alternative example, the mounting portion 610 may also be fixedly connected to the inner wall of the fluid cavity 111 through, for example, screws, bolts, or the like.

As shown in FIG. 13, in this example, the axial projection of the barrier mechanism 600 covers a length L of the cutting member 220 along a horizontal direction and a height H of the cutting member 220 along the vertical direction, a diameter of the cutting member is D, and L/D≥⅔ and H/D≥⅔.

A horizontal distance of the axial projection of the barrier mechanism 600 in the entry region is ΔL, and ΔL/D≥⅙; and a vertical distance between a top of the barrier mechanism 600 and the rotation center 221 is ΔH, and ΔH/D≥⅙.

It is to be understood that the barrier mechanism 600 has a length L1 along the horizontal direction, where L1≥⅔D, and a top edge 620 of the barrier mechanism 600 is higher than the rotation center 221 of the cutting member 220 by a height ΔH1, where ΔH1≥⅙D; the barrier mechanism 600 has a height H1 along the vertical direction, where H1≥⅔D, and an entry edge 630 of the barrier mechanism 600 is disposed on a left side of the rotation center 221 of the cutting member 220 and a distance between the entry edge 630 and the rotation center 221 is ΔL1, where ΔL1≥⅙D. In other words, the top edge and the entry edge of the barrier mechanism 600 each extend beyond the rotation center 221 of the cutting member 220, and a distance by which the top extends beyond the rotation center 221 and a distance by which the entry edge 630 extends beyond the rotation center 221 are each equal to or greater than ⅙D.

The barrier mechanism 600 may be a rectangular plate, a sector-shaped plate, or the like. Of course, the barrier mechanism 600 may be an irregular plate as long as the axial projection of the barrier mechanism 600 covers the cutting member 220 as required above.

The barrier mechanism 600 in this example is the irregular plate and includes the top edge 620, the entry edge 630, and a connection edge 640. The top edge 620 is at the top of the barrier mechanism 600 and disposed approximately horizontally. The entry edge 630 is on a side of the barrier mechanism 600 facing away from the fixing lug 612 and disposed approximately vertically. The connection edge 640 transitionally connects the fixing lug 612 to the entry edge 630.

It is to be understood that the connection edge 640 of the barrier mechanism 600 may be an arc-shaped edge, a straight edge, or a special-shaped edge as long as the connection edge 640 can completely shield a rim of the cutting member 220 on an inner side of the barrier mechanism 600.

Further, in this example, an axial gap between an inner surface of the barrier mechanism 600 and the cutting member 220 is g1″ and 1/20≤g1″/r≤⅛, for example, 1/11≤g1″/r≤ 1/10, where the axial gap g1″ in this example approximately satisfies that 0 mm<g1″≤8 mm.

The barrier mechanism 600 is configured to cover the rotation center of the cutting member 220 and extend beyond the horizontal center line and the vertical center line of the cutting member, which prevents the coolant driven through rotation of the cutting member from being splashed to a large scale, improves a utilization rate of the coolant, prevents a user from frequently adding the coolant, and avoids environmental pollution caused by the splashing of the coolant.

As shown in FIG. 16, the barrier mechanism 600 further includes a flow limiting surface 650 and a flow blocking member 660 disposed on the inner surface of the barrier mechanism 600. The inner surface refers to a surface of the barrier mechanism 600 facing toward the cutting member 220. The barrier mechanism 600 is provided with a boss protruding toward the cutting member 220, and the flow limiting surface 650 is formed on the boss. In addition, an axial gap g2 between the flow limiting surface 650 and the cutting member 220 approximately satisfies that 0 mm<g2≤8 mm, for example, g2 is 6 mm. The axial gap g2 is smaller than the axial gap g1″ between the inner surface of the barrier mechanism 600 and the cutting member 220.

An axial gap g3 between the flow blocking member 660 and a surface of the cutting member 220 may be smaller than or equal to the axial gap g2 between the flow limiting surface 650 and the cutting member 220. In this example, the axial gap g3 between the flow blocking member 660 and the surface of the cutting member 220 is smaller than the axial gap g2 between the flow limiting surface 650 and the cutting member 220.

As shown in FIG. 16, the flow blocking member 660 is disposed at one angle or more than one angle with respect to a rotation direction of the cutting member 220, which can suppress the coolant brought out by the cutting member 220 at multiple angles and prevent the coolant from being splashed at multiple angles. The rotation direction of the cutting member refers to a direction approximately tangent to an outer rim of the cutting member.

The axial gap between the inner surface of the barrier mechanism 600 and the cutting member is limited and the flow limiting surface 650 and the flow blocking member 660 are disposed so that the splashing of the coolant during a cutting process can be further avoided and utilization efficiency of the coolant is further improved.

Of course, further, a plurality of flow discharge units, such as flow discharge ribs or flow discharge holes, are disposed on an inner wall of the barrier mechanism 600 for discharging the coolant splashed onto the inner wall of the barrier mechanism 600 during the cutting process into the fluid cavity in time. A flow discharge hole may be an opening formed between adjacent flow blocking members.

In this example, an axial gap g4 between the top edge 620 of the barrier mechanism 600 and the cutting member 220 is a minimum axial gap between the barrier mechanism 600 and the cutting member 220 and approximately satisfies that 0 mm<g4≤4 mm, for example, g4 is 3 mm.

Likewise, in this example, a flow jamming member 360 may further be disposed at a position of the barrier mechanism 600 where the cutting member 220 rotates out. The flow jamming member 360 is at least a soft baffle pad disposed at an exit end of the top edge 620 where the cutting member 220 exits. A gap between the flow jamming member 360 and the cutting member 220 is smaller than or equal to a gap between the top edge 620 and the cutting member 220. Specifically, the flow jamming member 360 may be a rubber pad which may be fixed on a sidewall of the fluid cavity 111 or fixed on the barrier mechanism 600. The soft baffle pad in this example is disposed transversely at an exit end of the barrier mechanism 600.

The top edge 620 of the barrier mechanism 600 and the flow jamming member 360 form a final obstacle to the coolant and are used for finally reducing an amount of the coolant rotating out with the cutting member 220, so as to avoid a large amount of splashes at a position of an operation bench 120 where the cutting member 220 exits, prevent a liquid from being accumulated, and prevent a large amount of dirty water from obscuring a cutting line and affecting cutting accuracy.

It is to be noted that the barrier mechanism 600 in the preceding example of the present disclosure may be used alone, that is, the barrier mechanism 600 is independently mounted on an axially outer side of the cutting member 220 in the fluid cavity 111. The barrier mechanism 600 may also be used in conjunction with the fluid control mechanism or the flow guiding cover in other examples described above and used for further improving a splash prevention effect of the cutting device and the utilization efficiency of the coolant.

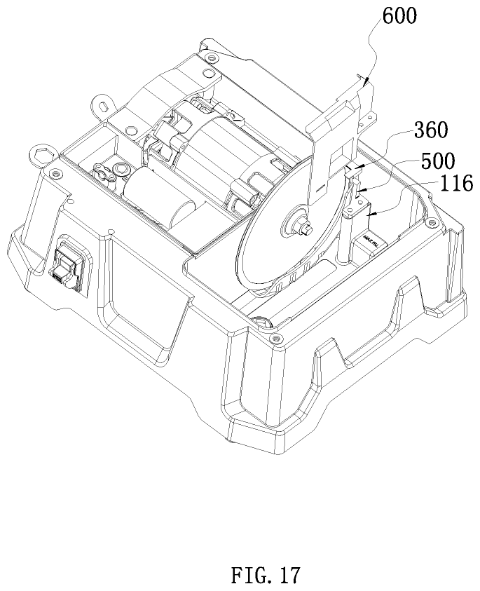

As shown in FIG. 17, an example of the present disclosure provides a cutting device 100. The cutting device 100 in this example is provided with not only a flow guiding cover 500 but also a barrier mechanism 600. The flow guiding cover, the barrier mechanism 600, a manner of fixing the barrier mechanism 600, a setting of positions where the barrier mechanism 600 covers a cutting member 220 are the same as those in the preceding examples. The details are not repeated here.

Specifically, the barrier mechanism 600 is disposed on an axially outer side of the flow guiding cover 500 for further limiting axial splashing caused by the cutting member 220 during rotation.

Of course, as an alternative example, an axial housing portion 520 may not be disposed. In this case, an outer surface of a support sidewall 111b′ on an inner side of the cutting member 220 forms one flow guiding plane surface for the cutting member 220, or several plane bosses are disposed on the support sidewall 111b′ and a plane surface of the plane bosses facing toward the cutting member 220 forms the flow guiding plane surface. Meanwhile, an inner surface of the barrier mechanism 600 on an axially outer side of the cutting member 220 may form a flow guiding plane surface 321 on the axially outer side of the cutting member 220. An axial gap between the formed flow guiding plane surface 321 and a surface of the cutting member 220 is g and 1/20≤g/r≤⅛, for example, 1/11≤g/r≤ 1/10; and g also satisfies that 0 mm<g≤8 mm.

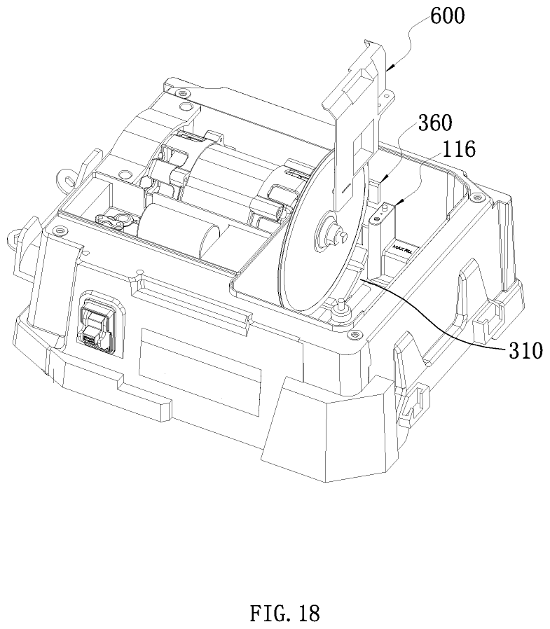

As shown in FIG. 18, an example of the present disclosure provides a cutting device 100. The cutting device 100 in this example is provided with not only a fluid control mechanism but also a barrier mechanism 600. The fluid control mechanism, the barrier mechanism 600, a manner of fixing the barrier mechanism 600, a setting of positions where the barrier mechanism 600 covers a cutting member 220 are the same as those in the preceding examples. The details are not repeated here.

Specifically, the barrier mechanism 600 is disposed on an outer side of an arc-shaped boss formed on the fluid control mechanism and used for further limiting axial splashing caused by the cutting member 220 during rotation.

Further, in this case, an inner side surface of the barrier mechanism 600 may form a flow guiding plane surface 321 on an axially outer side of the cutting member 220. An axial gap between the formed flow guiding plane surface 321 and a surface of the cutting member 220 is g and 1/20≤g/r≤⅛, for example, 1/11≤g/r≤ 1/10; and g also satisfies that 0 mm<g≤8 mm.

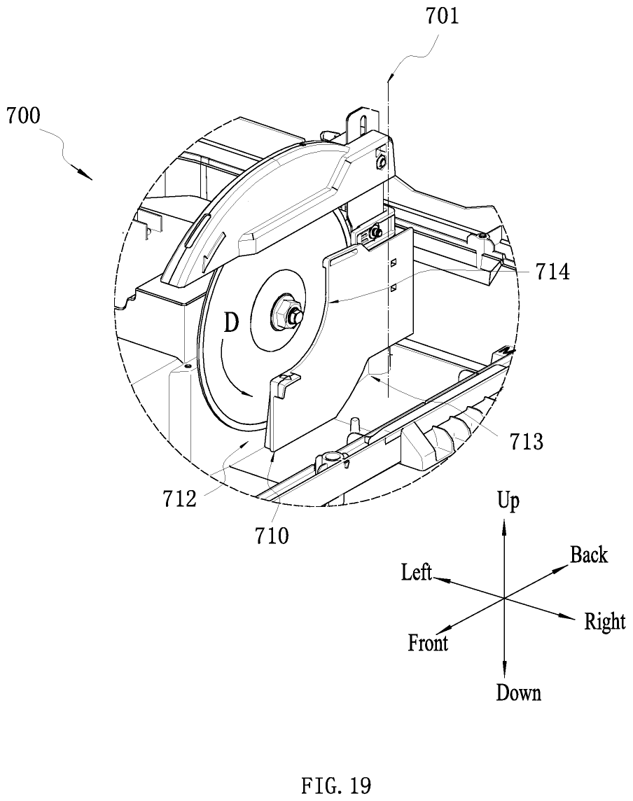

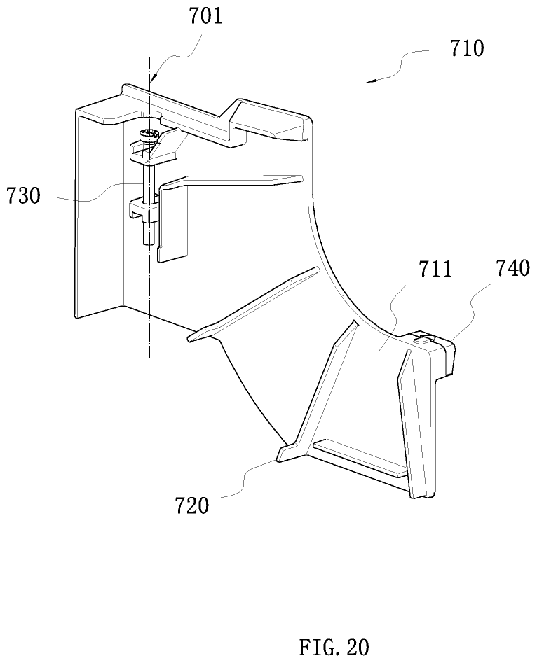

In another example of the present disclosure, as shown in FIGS. 19 and 20, a structure of a cutting device 700 is mostly the same as or similar to the structure in the preceding example, and merely differences from the preceding example are described in this example for convenience. For convenience of description, directions such as “up”, “down”, “left”, “right”, and the like as shown in FIG. 19 are also defined in this example. The preceding words indicating directions are used for describing relative position relations of components.

The cutting device 700 includes a flow guiding cover detachably disposed in a fluid cavity and including a main housing portion 710 disposed around a periphery of a cutting member. The main housing portion 710 at least partially surrounds one side of the cutting member so that a fluid can flow along an inner wall of the main housing portion 710. Specifically, the main housing portion 710 at least partially surrounds a circumferential side of the cutting member. However, unlike the barrier mechanism 600, the flow guiding cover in this example has both flow guiding and blocking effects.

The flow guiding cover moves with respect to the cutting member. The flow guiding cover has a first movement direction, and the first movement direction is a direction where at least part of the flow guiding cover moves away from the cutting member. In this example, the flow guiding cover rotates about a first straight line 701, and the main housing portion 710 is pivotally connected to structures such as a base through a first straight line 701. The first straight line 701 is provided with an elastic member which can limit a movement range of the flow guiding cover within a certain range. An operation member 740 is also disposed on the flow guiding cover for operating the flow guiding cover to rotate by an angle. When the flow guiding cover is rotatable, a user can replace a saw blade without removing a shield when replacing the cutting member. In addition, the flow guiding cover itself is a detachable structure so that the whole flow guiding cover is replaced more conveniently.

The flow guiding cover and the cutting member form a water entry region and a water discharge region 713. The water entry region includes a first water entry region 711 and a second water entry region 712. A part of the main housing portion 710 of the flow guiding cover located upstream in a rotation direction D of the cutting member is the first water entry region 711, and a space enclosed by a front side of the first water entry region 711 and a base is the second water entry region 712. Specifically, a position of the main housing portion 710 in a front-back direction is not beyond an outer peripheral rim of the cutting member so that a water flow channel at a front end of the main housing portion 710, above the base, and below the cutting member is the second water entry region 712. Further, a flow guiding unit similar to that in the preceding example may be disposed in the second water entry region 712.

Further, an interval exists between the main housing portion 710 and the cutting member, and several partitions 720 are disposed in the first water entry region 711. Specifically, the partition 720 is a divider having a certain height and perpendicular to the main housing portion 710. The partitions 720 include a transverse partition disposed at a lower portion of the first water entry region 711 along a circumferential direction of the cutting member and radial partitions disposed along radial directions of the cutting member, where the radial partitions are disposed on two sides of the transverse partition. The preceding transverse partition and longitudinal partitions collectively surround a periphery of the first water entry region 711. The transverse partition is disposed so that a sectional area of the water entry region is reduced and a water flow is prevented from being splashed outside.

A part of the flow guiding cover located downstream in the rotation direction of the cutting member is the water discharge region 713. A relatively large interval exists between a lower edge of the water discharge region 713 and an inner wall of the base so that smooth water discharge is ensured. Merely the radial partitions are disposed in the water discharge region 713 for guiding the water flow.

In another implementation of this example, the flow guiding cover may not be provided with the transverse partition, and a distance between a lower end of the flow guiding cover and a bottom of the base may be less than 20 mm, especially less than 15 mm. This example can also maintain the sectional area of the water entry region to be a small value, ensuring that the water flow can enter the flow guiding cover in an orderly manner from the first water entry region and is not splashed.

Further, an upper edge 714 of the main housing portion 710 does not exceed a rotation center of the cutting member, and the upper edge 714 may have an arc shape consistent with a shape of the cutting member. Since the cutting member is generally provided with a protruding transmission structure at the rotation center of the cutting member, the preceding structure can make the main housing portion 710 closer to the cutting member so that the water flow passing through the cutting member forms a relatively stable laminar flow or the like.

In this example, the cutting member is provided with a protruding base housing on a side opposite to a side where the flow guiding cover is disposed, and the flow guiding cover is disposed on merely one side of the cutting member. In other examples, the flow guiding cover may also be disposed on two sides of the cutting member and is opened in opposite movement directions separately.

The above illustrates and describes basic principles, main features, and advantages of the present disclosure. It is to be understood by those skilled in the art that the preceding examples do not limit the present disclosure in any form, and technical solutions obtained by means of equivalent substitutions or equivalent transformations fall within the scope of the present disclosure and appended claims.

What is claimed is:

1. A cutting device, comprising:
a base comprising a fluid cavity for containing a fluid;
an operation bench disposed on the base; and
a cutting mechanism comprising a driving member and a cutting member;
wherein the driving member drives the cutting member to rotate, the cutting member at least partially protrudes from and passes through the operation bench, the cutting device further comprises a radial flow guiding member disposed in the fluid cavity, the radial flow guiding member comprises at least a flow guiding surface disposed around a periphery of the cutting member, the fluid is capable of flowing along the flow guiding surface, and the flow guiding surface is inclined or curved with respect to a bottom wall of the fluid cavity.

2. The cutting device according to claim 1, wherein the flow guiding surface comprises a flow guiding curved surface which is substantially disposed on a circumference with an axis of the cutting member as a center line.

3. The cutting device according to claim 2, wherein a radial gap between the flow guiding curved surface and the cutting member is Δd, a radius of the cutting member is r, and 1/20 ≤Δd/r≤ 1/9.

4. The cutting device according to claim 2, wherein a radial gap between the flow guiding curved surface and a rim of the cutting member is less than or equal to 8 mm.

5. The cutting device according to claim 1, wherein the fluid cavity comprises the bottom wall and the flow guiding curved surface extends from the bottom wall along a rotation direction of the cutting member.

6. The cutting device according to claim 5, wherein the flow guiding curved surface extends from a position directly below the cutting member along the rotation direction of the cutting member by an angle α, wherein α≥70°.

7. The cutting device according to claim 2, wherein the cutting device further comprises an axial flow guiding unit comprising flow guiding plane surfaces disposed on two axial sides of the cutting member and spaced apart from the cutting member.

8. The cutting device according to claim 7, wherein a height of each of the flow guiding plane surfaces is h, a radius of the cutting member is r, and ¼≤h/r≤1.

9. The cutting device according to claim 7, wherein an axial gap between each of the flow guiding plane surfaces and a surface of the cutting member is g, a radius of the cutting member is r, and 1/20≤g/r≤⅛.

10. The cutting device according to claim 7, further comprising a baffle plate disposed at an axial end of the cutting member and the baffle plate is inserted into or pivotally connected to the base and each of the flow guiding plane surfaces is formed on any one or more of a boss in the fluid cavity, a sidewall of the fluid cavity, and the baffle plate.

11. The cutting device according to claim 1, wherein the cutting device further comprises a flow blocking unit disposed on the radial flow guiding member and/or an axial flow guiding unit, a radial gap between the flow blocking unit and the cutting member is smaller than a radial gap between a flow guiding curved surface and the cutting member, and an axial gap between the flow blocking unit and the cutting member is smaller than an axial gap between a flow guiding plane surface and the cutting member.

12. The cutting device according to claim 2, wherein the cutting device further comprises a flow stirring unit disposed on the flow guiding curved surface and the flow stirring unit is recessed on the flow guiding curved surface toward a radially outer side of the flow guiding curved surface.

13. The cutting device according to claim 1, wherein the cutting device further comprises a flow jamming member and the flow jamming member is a soft baffle pad.

14. The cutting device according to claim 1, wherein the cutting member has an entry region and an exit region on a rotation path of the cutting member, the entry region refers to a rotation path where the cutting member enters the fluid and rotates to a lower limit position, the exit region refers to a rotation path where the cutting member rotates from the lower limit position until the cutting member exits from the fluid, the cutting device further comprises a barrier mechanism mounted at an axial end of the cutting member in the fluid cavity along a direction approximately perpendicular to a first axis, the barrier mechanism covers at least the exit region of the cutting member, and an axial projection of the barrier mechanism extends beyond a vertical center line of the cutting member toward the entry region and extends upward beyond a horizontal center line of the cutting member.

15. The cutting device according to claim 14, further comprising a flow limiting surface disposed on an inner surface of the barrier mechanism and an axial gap between the flow limiting surface and the cutting member is smaller than an axial gap between the inner surface of the barrier mechanism and the cutting member.

16. The cutting device according to claim 14, further comprising a flow blocking member disposed on an inner surface of the barrier mechanism and the flow blocking member is disposed at one angle or more than one angle with respect to a rotation direction of the cutting member.

17. The cutting device according to claim 1, wherein the radial flow guiding member is disposed in the fluid cavity, the radial flow guiding member comprises at least a flow guiding curved surface disposed around the periphery of the cutting member, the flow guiding curved surface is substantially disposed on a circumference with an axis of the cutting member as a center line, and a barrier mechanism is disposed on an axially outer side of the radial flow guiding member.

18. The cutting device according to claim 1, further comprising a flow guiding cover, the flow guiding cover is connected to the fluid cavity and disposed in the fluid cavity, the flow guiding cover comprises a main housing of a circumferential housing disposed around the periphery of the cutting member, the main housing of the circumferential housing comprises a flow guiding curved surface which is substantially disposed on a circumference with an axis of the cutting member as a center line, and a barrier mechanism is disposed on an axially outer side of the radial flow guiding member.

19. A cutting device, comprising:
a base comprising a fluid cavity for containing a fluid;
an operation bench disposed on the base; and
a cutting mechanism comprising a driving member and a cutting member;
wherein the driving member drives the cutting member to rotate, the cutting member at least partially protrudes from and passes through the operation bench, the cutting device further comprises a flow guiding cover detachably disposed in the fluid cavity, the flow guiding cover comprises a main housing portion disposed around a periphery of the cutting member, the fluid is capable of flowing along an inner wall of the main housing portion, and the inner wall of the main housing portion is inclined or curved with respect to a bottom wall of the fluid cavity.

20. A cutting device, comprising:
a base comprising a fluid cavity for containing a fluid;
an operation bench disposed on the base; and
a cutting mechanism comprising a driving member and a cutting member;
wherein the driving member drives the cutting member to rotate, the cutting member at least partially protrudes from and passes through the operation bench, the cutting device further comprises a flow guiding cover detachably disposed in the fluid cavity, the flow guiding cover comprises a main housing portion disposed around a periphery of the cutting member, the main housing portion surrounds at least a part of one side of the cutting member, the fluid is capable of flowing along an inner wall of the main housing portion, and the flow guiding cover moves with respect to the cutting member.
